(19) United States
(12) Patent Application Publication
(10) Pub. No.: US 2026/0152882 A1
(43) Pub. Date: Jun. 4, 2026

(54) MOPPING SYSTEM

(71) Applicant: CONTEC, INC., SPARTANBURG, SC (US)

(72) Inventors: MAI BLACKWELL, CAMPOBELLO, SC (US); LAYNE ROSS, SIMPSONVILLE, SC (US); PAUL LATTEN, CLOVER, SC (US)

(21) Appl. No.: 19/122,957

(22) PCT Filed: Oct. 30, 2023
(86) PCT No.: PCT/US2023/078197

§ 371 Date: Apr. 21, 2025

Related U.S. Application Data
(60) Provisional application No. 63/421,713, filed on Nov. 2, 2022.

(51) Int. Cl. D04H 1/4382; A47L 13/16; A47L 13/256; A47L 13/42; D04H 1/435; D04H 1/4374; D04H 1/52; D04H 1/541; D04H 1/558

(52) U.S. Cl. CPC D04H 1/43835; A47L 13/16; A47L 13/256; A47L 13/42; D04H 1/435; D04H 1/4374; D04H 1/43828; D04H 1/43838; D04H 1/52; D04H 1/5412; D04H 1/5418; D04H 1/558; D10B 2509/026

(57) ABSTRACT

A mopping system incorporating a multi-layer disposable fibrous mop pad adapted for attachment to a mop head which provides substantial absorption and cleaning efficacy. The disposable mop pad includes a nonwoven absorptive base layer or core in operative attached relation to a surface layer adapted to engage the surface being cleaned. The base layer takes up cleaning and/or disinfecting solution for release during the cleaning operation while the surface layer provides a surface for scrubbing dirt removal and particle retention prior to disposal.

### CROSS-REFERENCE TO RELATED APPLICATION(S)

This application claims the benefit of, and priority from, U.S. provisional application 63/421,713 filed Nov. 2, 2022, the contents of which are hereby incorporated by reference herein in their entirety.

### TECHNICAL FIELD

The present disclosure relates generally to cleaning products, and more particularly to cleaning systems for floors and other surfaces using an absorptive fibrous structure adapted to removably engage a mop head. Exemplary non-limiting environments of use may include clean rooms, pharmaceutical laboratories, hospitals, and the like.

### BACKGROUND

It is well known to use cleaning and disinfecting solutions to treat various environments such as healthcare environments, food preparation and manufacturing areas, and electronics and pharmaceutical clean rooms. Such treatment solutions are typically applied using foam or fiber mops which collect the treatment solution from a bucket or other bulk storage device. The mop is then used to disperse the treatment solution to the surface being cleaned and to collect the used treatment solution after it has been applied. These traditional mop structures may thus lead to recycling of contaminated or diluted treatment solution as it is expelled and then drawn back into the mop during multiple cycles.

To address the issue of recycling treatment solutions, the industry is moving towards disposable pads and the like that can be used for defined areas and then be discarded. While such systems provide substantial hygiene benefits, some current disposable pads may be relatively expensive. Thus, a user may be tempted to use the same pad in multiple areas thereby impacting the overall benefit of reduced contamination.

In light of these deficiencies, a useful advancement would be derived from a system providing adequate fluid absorption and secure mop attachment for effective cleaning while also using relatively low-cost materials and manufacturing practices.

### SUMMARY

The present disclosure offers advantages and alternatives over the prior art by providing a mopping system incorporating a multi-layer disposable fibrous mop pad adapted for attachment to a mop head which provides substantial absorption and cleaning efficacy. The disposable mop pad includes a nonwoven absorptive base layer (also referred to as a core) in operative attached relation to a surface layer adapted to engage the surface being cleaned. The base layer takes up cleaning and/or disinfecting solution for release during the cleaning operation while the surface layer provides a surface for scrubbing dirt removal and particle retention prior to disposal. The base layer also preferably defines a suitable attachment surface for hook and loop connection to a mop head incorporating downwardly projecting hooking elements.

In accordance with one exemplary construction, the present disclosure provides A mopping system including a multi-layer fibrous pad structure adapted to engage a plurality of hooking elements projecting away from a user manipulated mop head to establish a reversible hook and loop connection. The pad structure includes an upper base layer operatively connected to a lower surface layer. The upper base layer may include about 30% to 70% by weight staple polyester fibers having a first linear density in blended and thermobonded relation with about 30% to 70% bicomponent PET fibers having a second linear density at least 2 times that of the staple PET fibers. The upper base layer has an inherent water retention capacity of not less than 20 grams water per gram of fiber. The multi-layer fibrous pad structure further includes a fibrous lower surface layer such as a stich-bonded fabric or the like operatively connected to the upper base layer and including a plurality of multifilament micro-denier stitching yarns stitched through a fiber fleece.

Other features and advantages of the disclosure will become apparent to those of skill in the art upon review of the following detailed description, claims and drawings. Before the exemplary embodiments of the disclosure are explained in detail, it is to be understood that the present disclosure is in no way limited in its application or construction to the details and the arrangements of the components set forth in the following description or illustrated in the drawings. Rather, the subject matter of the disclosure is capable of other embodiments and of being practiced or being carried out in various ways. Also, it is to be understood that the phraseology and terminology used herein are for purposes of description only and should not be regarded as limiting. The use herein of terms such as “including” and “comprising”, and variations thereof is meant to encompass the items listed thereafter and equivalents thereof as well as additional items and equivalents thereof.

### BRIEF DESCRIPTION OF THE DRAWINGS

The accompanying drawings which are incorporated in, and which constitute a part of this specification illustrate exemplary constructions and procedures in accordance with the present disclosure and, together with the general description given above, and the detailed description set forth below, serve to explain the principles of the disclosure wherein:

FIG. 1 illustrates an exemplary mopping system in accordance with one exemplary embodiment of the present disclosure incorporating a mop head, and an engageable fibrous pad structure having an absorptive base layer and an attached cleaning surface layer;

FIG. 2 illustrates the mopping system of FIG. 1 with the pad structure attached and showing an exemplary pattern of cleaning liquid discharge and take-up; and

FIG. 3 is an exploded view of an exemplary pad structure with the absorptive base layer separated from the surface cleaning layer.

While the disclosure has been illustrated and will hereinafter be described in connection with certain exemplary embodiments and practices, it is to be understood that in no event is the disclosure to be limited to such illustrated and described embodiments and practices. On the contrary, it is intended that the present disclosure shall extend to all alternatives and modifications as may embrace the general principles of this disclosure within the full and true spirit and scope thereof.

### DESCRIPTION

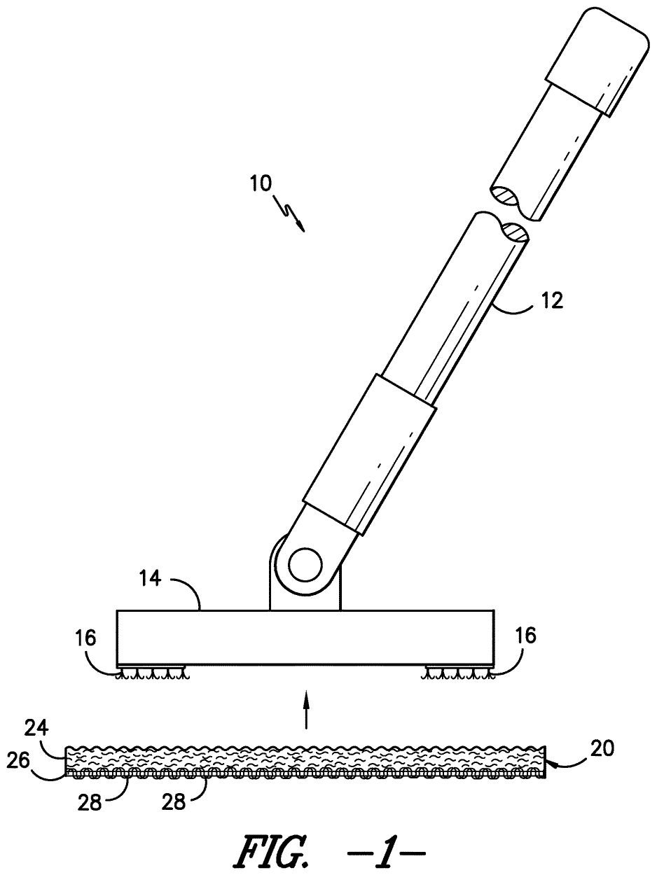

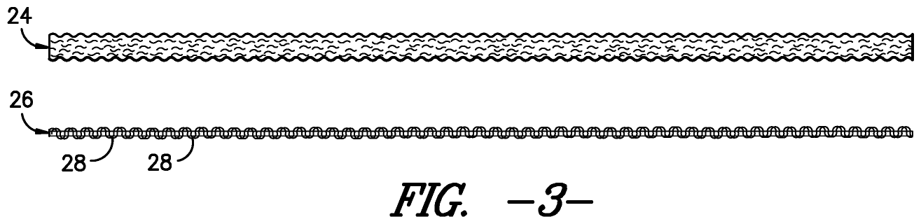

Exemplary embodiments will now be described through reference to potentially preferred constructions and practices. Turning now to the drawings, FIGS. 1-3 illustrate an exemplary embodiment for a mopping system 10 in accordance with the present disclosure. In this exemplary embodiment, a user manipulated handle 12 may be operatively connected to a mop head 14 as will be well known to those of skill in the art. The underside of mop head 14 may include an arrangement of hooking elements 16 defining one half of a hook and loop attachment structure. By way of example only, and not limitation, the hooking elements 16 across the underside of the mop head 14 may project away from a film backing which is secured to the underside of the mop head by an adhesive or by other suitable technique as may be desired. However, other suitable hooking element configurations such as internally molded hooks or the like may also be used. The hooking elements 16 may be disposed in a discontinuous pattern across the underside of the mop head 14 or may be substantially continuous. Taller hooks with heights in the range of as 0.035 inch or greater may be beneficial for penetration into an absorptive base layer 24 as will be described further hereafter to increase attachment strength to mop head 14 and reduce fiber sheading into hooking elements.

Any suitable hook shape can be used for hooking elements 16. By way of example only, and not limitation, the individual hooking elements 16 may have J-shaped free ends, double hook free ends or generally flat enlarged heads having a mushroom shape or the like. The hooking elements 16 are typically formed from a relatively stiff resilient polymer to provide a relatively high peal force in a connection between mop head 14 and an underlying disposable pad structure 20 to be attached.

As shown, hooking elements 16 may connect in a releasable manner to the upper surface of pad structure 20. By way of example only, and not limitation, pad structure 20 may include a fibrous nonwoven absorptive base layer 24 in juxtaposed relation to a surface layer 28 such as a knit, woven or stitch-bonded fabric 26 adapted to provide cleaning and/or particle collection during a mopping operation.

Absorptive base layer 24 may be formed from a suitable fluid retaining fibrous material having adequate internal coherency to maintain structural integrity during use and a void volume to hold a treatment fluid until the application of pressure causes expulsion of the treatment fluid from the voids. The use of at least 30 percent by weight (more preferably at least 40% by weight) fine staple fiber in the absorptive base layer 24 which is blended and thermally bonded with a heavier bicomponent fiber with a low melting point component to form fiber to fiber point bonds within the matrix may be preferred. In this regard, a fine fiber constituent having a linear density in the range of 1 denier to 2.5 denier and a bicomponent fiber having a liner density in the range of about 3 denier to 5 denier may be desirable. However, higher and lower denier ranges may be used. The heavier denier fiber may preferably have a linear density at least 2 times that of the fine fiber. Using 30 percent to 70 percent fine fiber such as 1.5 denier PET staple blended and thermobonded with 30 percent to 70 percent of a heavier bicomponent such as a 4 denier core/sheath copolyester PET, may be particularly preferred. The bicomponent PET fibers preferably have a sheath of low melting point PET having a melting point less than 150 degrees C. (more preferably about 110 degrees C.) surrounding a core of PET having a melting point greater than 200 C.

Surface layer 26 may also be formed from fiber and have a construction adapted to collect and retain both particles and used fluid during cleaning. By way of example only and not limitation, surface layer 26 may be a stich-bonded fabric formed by stitching multifilament micro-denier stitching yarns 28 of polyester or the like through a nonwoven spun-bond made from polyester, polypropylene, nylon, or the like in a manner as will be well known to those of skill in the art. Stitching yarns 28 may form slightly raised surface loops across the underside to facilitate particle collection during cleaning. However, flat stiches may also be used if desired. In this regard, a looped construction may have a slightly higher coefficient of friction during use. A surface layer 26 with at least a majority by weight of stitching yarns having a denier per filament (dpf) rating of less than 1 denier per filament, and more preferably, about 0.1 to 0.9 dpf may be preferred. All stitching yarns may have a denier per filament (dpf) rating of less than 1 if desired.

Absorptive base layer 24 and surface layer 26 may be joined by a suitable technique permitting fluid transport between the layers. By way of example only, and not limitation, absorptive base layer 24 and surface layer 26 may be joined by a needling step using barbed needles to force portions of fibers across the interface between the layers. Such needling joinder may take place by introducing the preformed material defining the surface layer 26 into the needling process during formation of the base layer. In this regard, base layer 24 may be formed by first carding, then cross-lapping and then needling before thermobonding. Introducing base layer 26 into the needling process eliminates the need for a separate needing process to join the layers together. Of course, a separate needling process after the base layer is fully formed may be used if desired. Likewise, base layer 24 and surface layer 26 may be joined by other techniques such as patterned adhesives or the like if desired.

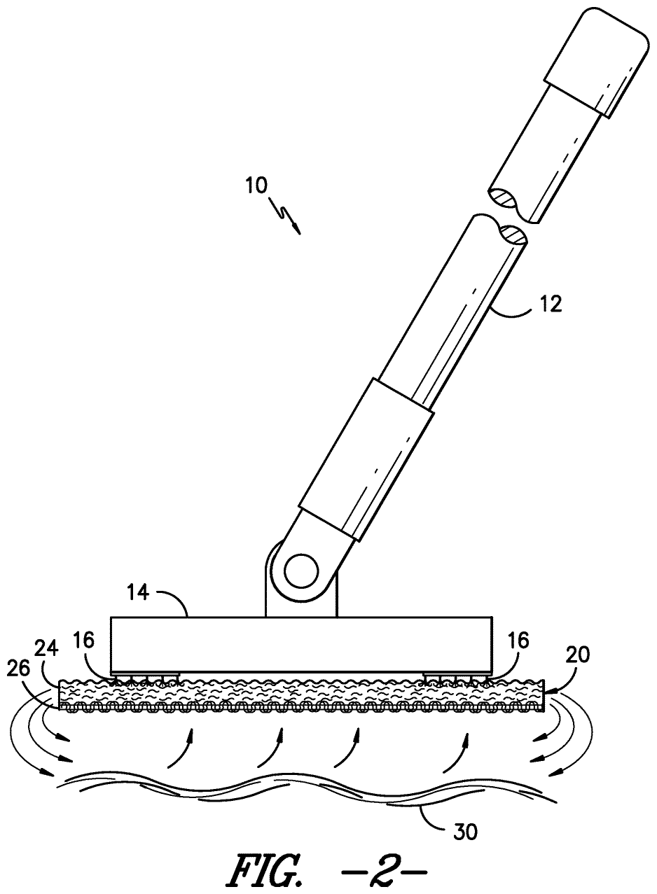

As best seen in FIG. 2, pad structure 20 may be secured to mop head 14 by engagement between hooking elements 16 and absorptive base layer 24. The pad structure 20 then may be immersed in a cleaning and/or disinfecting solution to substantially saturate the absorptive base layer 24. During subsequent mopping, the application of a compressive force to the pad structure 20 will cause treatment fluid 30 to be expelled outwardly from the absorptive base layer across a surface to be treated. As the mopping system is manipulated across the surface to be treated, the micro-fiber stitching yarns 28 provide a cleaning action to loosen and collect any solid material and the used, contaminated fluid is drawn away from the treated surface. Thus, the surface being treated is cleaned and dried. The pad structure 20 may then be removed and replaced with a fresh pad. Of course, a user may elect to replace the used pad structure at any point during the cleaning operation as may be desired.

The use of fine fiber in the absorptive base layer 24 such as 1.5 denier PET blended and thermally bonded with a heavier bicomponent may provide significant benefits in the absorption capacity of the base layer 24. In this regard, it has been found that the absorptive base layer 24 may have an inherent water retention capacity of about 15 to 30 grams of water per gram of material (g/g) or more without any gels or other absorptive aids. In this regard, existing products typically exhibit about 9-12 g/g absorption. Without being limited to a specific theory, it is believed that there is a correlation between loft and sorbency wherein the more available volume for water or other liquid, the more absorption increases. It is believed that the fine fiber may aid in keeping weight low while also increasing the fiber surface area (matrix of fibers) thereby increasing capillary effect for liquid retention.

As noted previously, an exemplary basic process to create the absorptive base layer 24 is carding, followed by cross lapping followed by light mechanical entangling using tacking needles, and then thermo-bonding wherein the bicomponent fiber is heat activated to create point to point fiber bonds within the matrix. The low melt PET portion of the bicomponent undergoes melting and resolidification such that it acts like a glue to hold the non-low melt fibers in place. Higher concentrations of the bicomponent (above 30%) may also result in better dimensional stability, and more resistance to compression.

Increasing the bicomponent percentage above 30% by weight also reduces fiber pull out. Fiber shedding is important for end users because if a mop releases fibers into the molded micro hook frame, hooks will slowly become clogged with fibers over time thus losing attachment strength. To reduce fiber shedding, an optional singeing process may be applied using an open flame to apply heat to the back of the base layer. This process further ties down the fibers by melting the CoPET and PET more than the oven. Application of printing chemical binders may also be used.

In accordance with one exemplary practice, a percentage of the stitching yarns 28 in the surface layer 26 may be formed from low melting point fiber. By way of example only, in one exemplary construction, surface layer 26 may be formed by a stich bonding pattern alternating 8 ends (i.e. machine direction stitch lines) of microfiber followed by 8 ends of low melt PET yarn. Melting of the low melt PET yarn during lamination aids in attachment between the layers has been shown to increase bond strength between layers by a factor of 2 to 3 times, thereby providing sufficient bond strength in mopping or similar applications. Low melt yarn may also reduce drag forces required to move the mop across the surface being cleaned by reducing the microfiber surface area at the face. Specifically, when heat is applied in the lamination process, the loops of low melt PET yarn will contract, reducing their loop height below the microfiber yarn loop height. This will in turn reduce surface contact to the floor. This void space may also be useful for catching larger debris. Of course, a stich bonding pattern alternating 8 ends (i.e. machine direction stitch lines) of microfiber followed by 8 ends of low melt PET yarn is merely exemplary and any pattern of microfiber yarns and low melt yarns may be used. Moreover, the number of ends of microfiber yarns and low melt yarns in adjacent zones can be different to provide a surface pattern of as desired.

### EXAMPLES

The disclosure may be further understood by reference to the following nonlimiting examples.

### Example 1

In accordance with a first exemplary construction, a disposable pad structure is provided having an absorptive base layer of carded, cross-lapped, tacked (lightly mechanically entangled using needing process) thermo-bonded web having a basis weight in the range of about 100 grams per square meter to about 250 grams per square meter (preferably 135 to 180 grams per square meter) with a loft (i.e. thickness) of about 0.2 inches plus or minus 0.03 inches. However, greater lofts of up to about 0.5 inches or greater may be desirable for some uses. The absorptive base layer fiber content is preferably about 40% to 60% (preferably 50%) staple PET of about 1.5 denier in combination with about 40% to 60% (preferably 50%) bicomponent PET having a low melting point outer sheath (about 110 degrees C.) surrounding a higher melting point core. A bicomponent fiber with linear density of about 3-5 denier (preferably about 4 denier) may be preferred.

In this exemplary construction, the absorptive base layer may be attached to a surface layer of stitch-bonded microfiber nonwoven defining a face across the absorptive base layer for contacting the surface to be cleaned. The surface layer preferably has a basis weight of about 50-90 grams per square meter (preferably about 70 GSM) with a loft (thickness) of about 0.025 inches. However, other weights and thicknesses may also be used. By way of example only, such a surface layer may incorporate a stitching fleece of spun-bond PET fiber having a mass per unit area of about 25 GSM (grams per square meter) stitched with polyester microfiber DTY yarns (Drawn Textured Yarns) of about 150 denier such as 150/288 f (150 denier made up of 288 filaments) or the like such that the surface yarns are 100% microfiber. One exemplary stitching pattern is microfiber yarn diagonally stitched 8 to the left then 8 stitches right. However, other stitching patterns may also be used if desired. The base layer and the surface layer may be laminated together using tacking needles with a secondary process using ultrasonics and hot knife bonding.

### Example 2

In accordance with a second exemplary construction, a disposable mop is provided having a base layer of carded, cross-lapped, tacked (lightly mechanically entangled using needing process) thermo-bonded web having a basis weight in the range of about 100 to 700 grams per square meter to about 180 grams per square meter (preferably 135 to 180 grams per square) with a loft (i.e. thickness) preferably of about 0.2 inches +/− 0.03 inches. However, greater lofts of up to about 0.5 inches or greater may be desirable for some uses. The base layer fiber content is preferably about 40% to 60% (preferably 50%) staple PET of about 1.5 denier in combination with about 40% to 60% (preferably 50%) bicomponent PET having a low melting point outer sheath (about 110 degrees C.) surrounding a higher melting point core. A bicomponent fiber with linear density of about 3-5 denier (preferably about 4 denier) may be preferred.

In this exemplary construction, the base layer may be attached to a surface layer of stitch-bonded microfiber nonwoven defining a face across the base layer for contacting the surface to be cleaned. The surface layer preferably has a basis weight of about 50-90 grams per square meter (preferably about 70 GSM) with a loft (thickness) of about 0.025 inches. However, other weights and thicknesses may also be used. By way of example only, such a surface layer may incorporate a stitching fleece of spun-bond PET fiber having a mass per unit area of about 25 GSM stitched with about 50% polyester microfiber DTY yarns of about 150 denier such as 150/288 f or the like in combination with about 50% low melt polyester yarn (110 degrees C. melting point). One exemplary stitching pattern is 8 ends of microfiber yarn alternating with 8 ends of 150/38 f low melt PET. However, other stitching patterns may also be used if desired. The base layer and the surface layer may be laminated together using tacking needles in combination with an inline oven to activate low melt yarn and low melt staple fiber.

Of course, the present disclosure is subject to a wide array of alternatives. It is to be understood that preferred embodiments of this disclosure are described herein, including the best mode known to the inventors for carrying out the disclosure. However, variations of those preferred embodiments may become apparent to those of ordinary skill in the art upon reading the foregoing description. Skilled artisans may employ such variations as appropriate, and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Various features of the disclosure are set forth in the following claims.

What is claimed is:

1. A mopping system comprising:
a multi-layer fibrous pad structure adapted to engage a plurality of hooking elements projecting away from a user manipulated mop head to establish a reversible hook and loop connection, the pad structure comprising an upper base layer operatively connected to a lower surface layer, the upper base layer comprising 30% to 70% by weight staple polyester fibers having a first linear density in blended and thermobonded relation with 30% to 70% bicomponent PET fibers, the bicomponent fibers having a second linear density at least 2 times that of the staple PET fibers and wherein the upper base layer has an inherent water retention capacity of not less than 20 grams water per gram of fiber, the multi-layer fibrous pad structure further comprising a fibrous lower surface layer operatively connected to the upper base layer, wherein the lower surface layer comprises a plurality of multifilament micro-denier stitching yarns stitched through a fiber fleece.

2. The mopping system as recited in claim 1, wherein the upper base layer has a basis weight in the range of 135 to 700 grams per square meter.

3. The mopping system as recited in claim 1, wherein the upper base layer has a thickness of 0.15 to 0.5 inches.

4. The mopping system as recited in claim 1, wherein the upper base layer comprises 30% to 70% by weight staple PET fibers of linear density in the range of 1 denier to 2.5 denier in blended and thermobonded relation with 30% to 70% bicomponent PET fibers of liner density in the range of 3 denier to 5 denier.

5. The mopping system as recited in claim 1, wherein the upper base layer has an inherent water retention capacity of not less than 20 grams water per gram of fiber.

6. The mopping system as recited in claim 1, wherein the bicomponent PET fibers are core/sheath fibers having a sheath of low melting point PET having a melting point less than 180 degrees C. surrounding a core of PET having a melting point greater than 200 C.

7. The mopping system as recited in claim 1, wherein the fibrous lower surface layer comprises a stitch-bonded fabric.

8. The mopping system as recited in claim 1, wherein the fibrous lower surface layer is needled to the upper base layer.

9. The mopping system as recited in claim 1, wherein the multifilament micro-denier stitching yarns are polyester DTY stitching yarns.

10. The mopping system as recited in claim 9, wherein the fiber fleece is PET fiber fleece.

11. The mopping system as recited in claim 10, wherein the DTY stitching yarns are disposed through a PET fiber fleece in patterned relation with a plurality of at least partially melted stitching yarns of low melting point polyester.

12. A mopping system comprising:
a multi-layer fibrous pad structure adapted to engage a plurality of hooking elements projecting away from a user manipulated mop head to establish a reversible hook and loop connection, the pad structure comprising an upper base layer operatively connected to a lower surface layer, the upper base layer having a basis weight in the range of 135 to 700 grams per square meter and a thickness of 0.15 to 0.5 inches, the upper base layer comprising 30% to 70% staple PET fibers of linear density in the rage of 1 denier to 2 denier in blended and thermobonded relation with 30% to 70% bicomponent PET fibers, the bicomponent fibers having a linear density of 3 denier or greater at least 2 times that of the staple PET fibers and wherein the upper base layer has an inherent water retention capacity of not less than 20 grams water per gram of fiber, the multi-layer fibrous pad structure further comprising a fibrous lower surface layer of stitch-bonded fabric operatively connected by needling to the upper base layer, wherein the lower surface layer comprises a plurality of multifilament micro-denier DTY stitching yarns disposed through a PET fiber fleece in patterned relation with a plurality of at least partially melted polyester stitching yarns.
